(19) United States
(12) Patent Application Publication
(10) Pub. No.: US 2011/0304336 A1
(43) Pub. Date: Dec. 15, 2011

(54) Device and Method For Locating A Conduit

(75) Inventor: Steven Nostro, New City, NY (US)

(73) Assignee: CONSOLIDATED EDISON COMPANY OF NEW YORK, INC., New York City, NY (US)

(21) Appl. No.: 12/796,732

(22) Filed: Jun. 9, 2010

(51) Int. Cl. G01V 3/08

(52) U.S. Cl. 324/326

(57) ABSTRACT

A system and method of locating a conduit, such as an underground conduit is provided. The system includes a tracing device that is adapted to be coupled to a valve. The tracing device includes a bypass member that is movable between a first position and a second position, wherein the bypass member extends through the valve when in the second position. A tracing member is sealingly coupled to the tracing device and extends through the bypass member. An electrical signal is applied to the tracing member and a monitoring device is used to locate an electrical field created by the electrical signal.

### BACKGROUND OF THE INVENTION

The subject matter disclosed herein relates to a device and method for tracing nonconductive conduit that cannot be seen, such as a conduit located underground, and in particular to a device and method for tracing a pressurized gas conduit.

Conduits or pipes are used in a variety of applications to either transfer a material, such as a gas or liquid for example, from a first area to a second area. Other applications make use of conduits as a type of shield to protect an object, such as an electrical, telecommunications or other cable for example, from damage. Often, these conduits are located underground, or are arranged within a wall, making it difficult to precisely locate the conduit at a later date. It should be appreciated that if the conduits are made from a ferrous material, various techniques may be used that inject an electrical signal onto an exposed end of the conduit causing an electrical field to be created around the conduit. Various detectors may then be used to detect the electric field and locate the conduit, even if it is buried beneath the ground or within a wall of a building. Once the conduit is located, personnel in the area may take measures to avoid contacting or damaging the conduit.

One application that makes extensive use of conduits is in the delivery of natural gas from a provider to a residence. Natural gas main conduits are typically installed under a street and have branch connections that couple the gas main to a residence, office building or other facility. Often, the conduits used in a natural gas system are made from nonmetallic-plastic material, such as polyvinyl chloride or polyethylene (PE) for example. The branch natural gas conduits are usually installed underground and have a first valve (sometimes referred to as a curb valve) adjacent the main conduit near the street and a second valve adjacent the gas meter located in or near the residence or building.

It should be appreciated that it is desirable to avoid contact with the natural gas conduit when personnel are performing tasks such as digging or using power equipment. When plastic natural gas conduits were initially installed in the 1970's, the gas conduits were installed alongside conduits carrying electrical power lines. When work was to be performed in the area, the personnel located the electrical power lines (using a field detector). Since the personnel knew the natural gas conduits and electrical power conduits were adjacent to each other, the approximate location of the natural gas conduit was also ascertained.

Unfortunately, over time the conductors carrying the electrical power lines were upgraded, repaired or replaced. In many instances, such as when the electrical service to the residence or building was upgraded for example, the electrical power lines were installed in a different location. As a result, no conductive material was located adjacent to the natural gas conduit, making it difficult to accurately locate the natural gas conduit. In these situations, personnel typically rely on maps that were made at the time of installation to determine the approximate location of the natural gas conduit. Since it is often desirable to know an accurate location of the natural gas conduit, hand-dug holes are often made to locate the conduit. To avoid an inadvertent release of natural gas, these conduits are often depressurized between the curb valve and the meter valve.

While existing devices and systems for locating hidden conduits are suitable for their intended purposes, a need for improvement remains in providing a device and method of locating conduits without having dig holes or depressurizing the conduit.

### BRIEF DESCRIPTION OF THE INVENTION

According to one aspect of the invention, a device for locating a nonconductive conduit having a valve is provided. The device includes a first fitting having an end adapted to couple with the valve. A bypass member is having an axial opening is sealingly coupled to the first fitting. The bypass member a first end within the first fitting, the bypass member being movable between a first position and a second position. An end member is operably coupled to a second end of the bypass member. A tracing member is sealingly coupled to the end member and includes a portion arranged partially within the axial opening, the tracing member being movable through the end member and the bypass member.

According to another aspect of the invention, a method of locating a conduit is provided. The method includes closing a valve coupled to the conduit adjacent a portion of the conduit to be located. A tracing device is coupled to one side of the valve, the tracing device having a bypass member and a tracing member. The valve is opened. The bypass member is moved from a first position to a second position. The tracing member is inserted into the conduit.

According to yet another aspect of the invention, a tracing device for locating a conduit comprising is provided. The tracing device includes a coupling portion. A bypass member is sealingly coupled to the coupling portion. A fitting is coupled to the bypass member. A tracer member is sealingly coupled to the fitting.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a side plan view illustration, partially in section of a device for inserting a tracer member into a conduit;

FIG. 2 is a side plan view illustration, partially in section of the device of FIG. 1 coupled to a closed valve;

FIG. 3 is a side plan view illustration, partially in section, of the device of FIG. 1 coupled to an open valve;

FIG. 4 is a schematic illustration of the device of FIG. 1 coupled to a gas conduit system with a tracer member extended into a conduit; and,

FIG. 5 is a flow chart illustrating a method of locating a conduit that is not visible.

The detailed description explains embodiments of the invention, together with advantages and features, by way of example with reference to the drawings.

### DETAILED DESCRIPTION OF THE INVENTION

Embodiments of the present invention provide advantages in allowing the location of a nonvisible nonconductive conduit, such as a conduit located beneath the ground or within a wall for example. Other embodiments of the invention provide further advantages in inserting a tracer member, such as a wire for example, into a pressurized conduit.

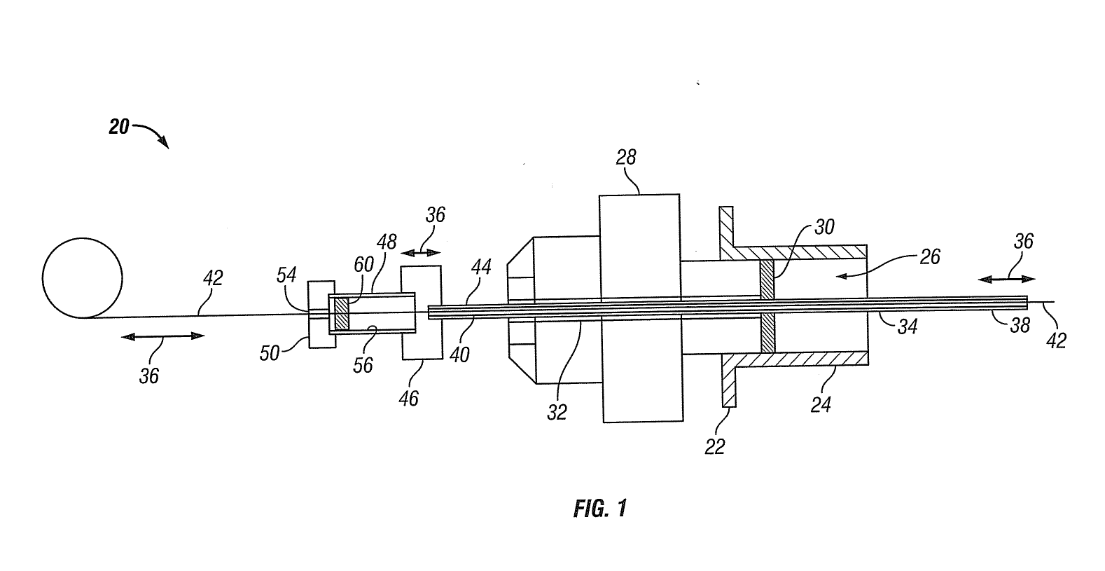

Referring to FIG. 1, an exemplary tracing device 20 for locating nonconductive or nonferrous conduits is illustrated. The tracing device 20 includes a first fitting 22 having a coupling portion 24 that is sized and configured to couple with a desired conduit, such as a natural gas conduit for example. In the exemplary embodiment, the coupling portion 24 has a 1-inch (25.4 millimeter) diameter and is threaded to be received in an outlet of a valve. The first fitting 22 has a substantially hollow interior portion 26. A compression fitting 28 is coupled to an end of the first fitting opposite the coupling portion 24. The compression fitting 28 includes an opening 32 that extends therethrough. As will be discussed in more detail below, the opening 32 is sized to allow a bypass member 34 to fit therein.

A seal 30 is disposed within the fitting 22, 28 assembly. In the exemplary embodiment, the seal 30 is a self-sealing polychloroprene seal/gasket material, such as Neoprene® manufactured by E.I. du Pont de Nemours and Company. As will be discussed in more detail, the seal 30 inhibits gas from a pressurized conduit from flowing through the tracing device 20 when the tracing device 20 is coupled to the conduit while simultaneously providing a sliding seal for the bypass member 34 to move within the opening 32 and interior portion 26. It should be appreciated that the seal 30 may be disposed on one end of the compression fitting 28, as illustrated for example, or may also be arranged within the compression fitting 28 or the first fitting 22.

The bypass member 34 is movably coupled to the compression fitting 28. In the exemplary embodiment, the bypass member 34 is movable in an axial direction 36 within the opening 32 and interior portion 26 between a first position and a second position. When in the first position, an end 38 of the bypass member 34 is positioned adjacent to or within the interior portion 26. The bypass member 34 includes an opening 40 that extends generally axially along the length of the bypass member 34. As will be discussed in more detail below, the opening 40 is sized to allow a tracer member 42 to pass therethrough. In the exemplary embodiment, the bypass member 34 has a rectangular cross-section. In one embodiment, the rectangular cross-section is sized to fit within a generally rectangular opening within a valve body opening. In another embodiment, the bypass member 34 has a width of 0.25 inches (6.35 millimeters) and a height of 0.5 inches (12.7 millimeters). In other embodiments, the bypass member 34 has a cross-section, such as a circular or oval cross-section for example, that is sized and shaped to fit within and through an opening in a valve body.

On an end 44 opposite end 38 of bypass member 34, a second fitting 46 is fixedly coupled to the bypass member 34. A member 48 is coupled to the second fitting 46 opposite the bypass member 34. The member 48 and second fitting 46 each have an opening 56 sized to allow the tracer member 42 to pass therethrough. A cap or third fitting 50 is coupled to the end of the bypass member 34. The third fitting 50 includes an opening 54 sized to allow the tracer member 42 to pass into the member 48. A second seal 60 is arranged in the opening 56. In the exemplary embodiment, the second seal 60 is a self-sealing neoprene gasket. As will be discussed in more detail below, the second seal allows the tracer member 42 to pass while inhibiting the flow of pressurized gas or fluid from an attached conduit.

It should be appreciated that the arrangement of the second fitting 46, member 48 and third fitting 50 is exemplary and the claimed invention should not be so limited. These fittings 46, 48, 50 may be combined in other configurations, such as single integrated member for example, that allow the tracer member 42 to pass into the opening 40 of bypass member 34 while inhibiting the flow of the gas or fluid in the conduit the tracing device 20 is coupled.

In the exemplary embodiment, the tracing member 42 is a coiled wire member having sufficient length, such as between 120-240 feet (36.6-76.2 meters) to extend the desired length of the conduit that the operator desires to locate. The tracing member 42 is electrically conductive and in the exemplary embodiment is made from antenna wire. In one embodiment, the tracing member 42 is a copper coated steel wire.

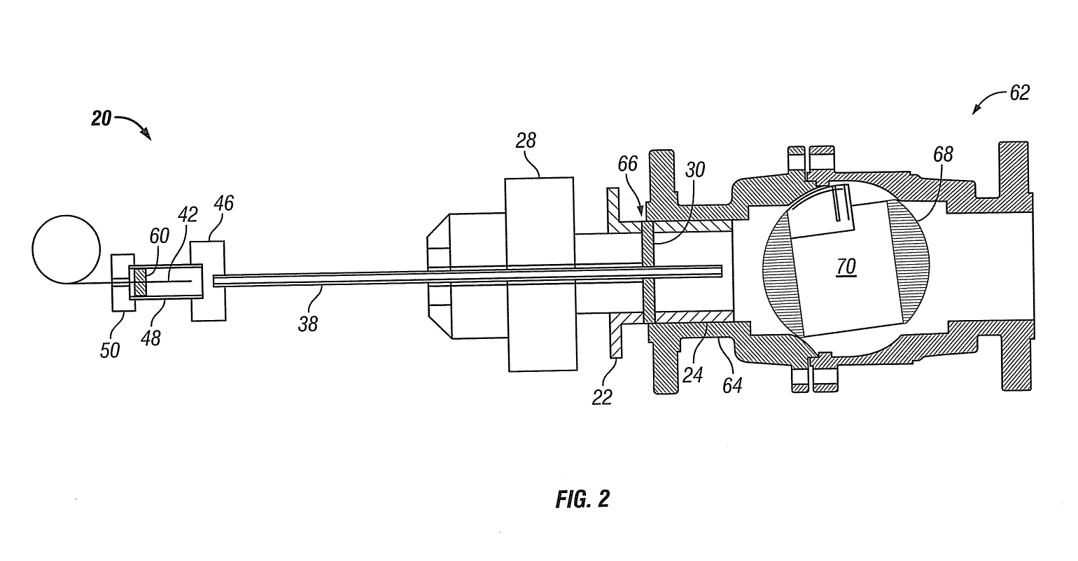

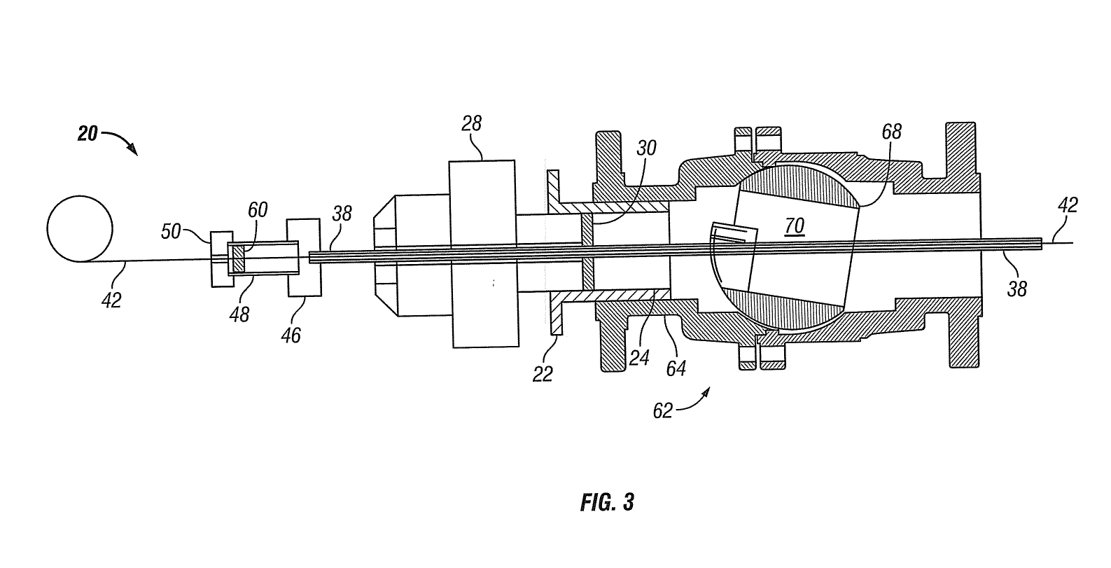

The tracing device 20 may be coupled to a valve 62 as illustrated in FIG. 2. The valve 62 may be any be any type of valve, such as a ball valve for example. The valve 62 includes an output end 64 that includes a coupling feature 66 that allows the first fitting 22 to be sealing coupled to the valve 62. The valve 62 further has a valve member, such as ball valve 68 for example, with an opening 70 therethrough that allows a fluid to pass when the valve 62 is in an open position FIG. 3), and prevents the flow of fluid when the valve 62 is in a closed position (FIG. 2).

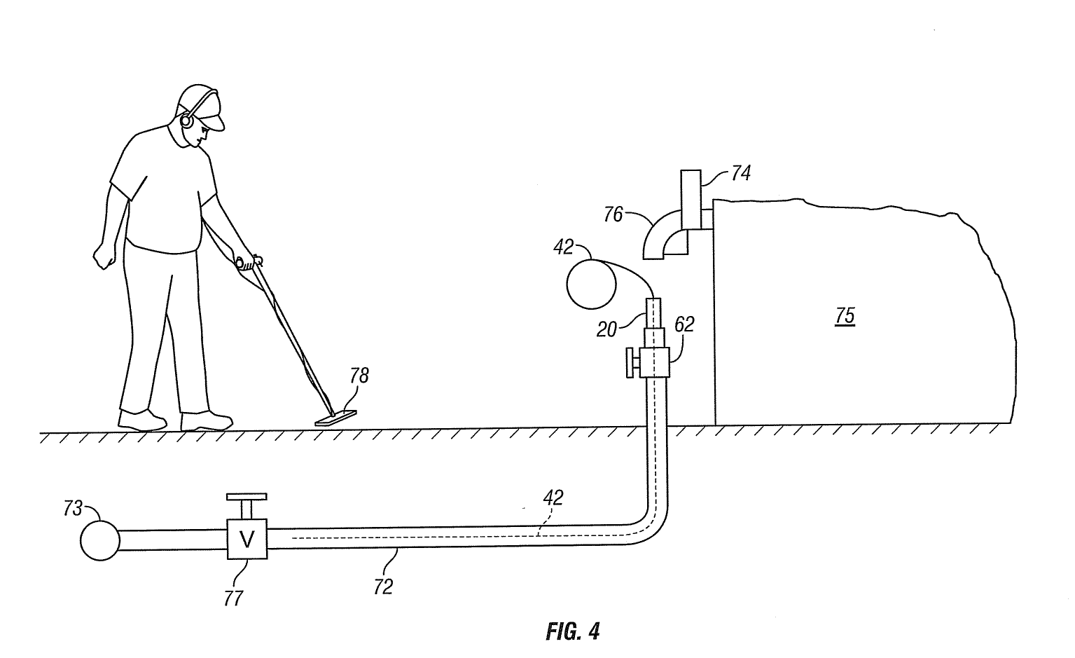

An exemplary embodiment of an application that may use the tracing device 20 is the delivery of natural gas as illustrated in FIG. 4. In some circumstances, it may be desirable to locate an underground conduit 72, such as when the ground is going to be excavated in the area for example. The conduit 72 connects a main supply conduit 73 to a meter 74 adjacent to a residence or building 75. Generally, a curb valve 77 is positioned between the main supply conduit 73 and the building 75 to allow service to be shut off for maintenance or repairs. Generally, the main supply conduit 73 is positioned under or adjacent to the street and the curb valve 77 is accessible via a service box (not shown).

In order to locate the underground conduit 72, a valve 62 located adjacent the meter 74 is moved to a closed position to prevent the flow of gas from the conduit 72 to the meter 74. With the valve 62 closed, a portion 76 of the conduit between the valve 62 and the meter 74 may be disconnected from the valve 62. The tracing device 20 is then coupled to the open side of valve 62 as illustrated in FIG. 2. It should be appreciated that with the tracing device 20 coupled to the valve 62, the valve 62 may be opened without gas flowing into the environment.

With the valve 62 opened, the opening 70 of the valve 62 is generally aligned with the axis of the conduit 72 and the tracing device 20. The service personnel may then move the bypass member 34 to a second position (FIG. 4) allowing the end 38 to pass through the opening 70 and into conduit 72. Once the bypass member 34 is moved to the second position, the service personnel may insert the tracing member 42 through the tracing device 20 and into the conduit 72 without interference from the internal components of the valve 62. As the service personnel insert the tracing member 42, the tracing member 42 will travel within the conduit 72. In testing, the tracing member 42 was inserted and the underground conduit 72 was detected over a length of 150 feet (45.7 meters) and it is contemplated that greater than 250 feet of underground conduit may be located in this manner.

Once a desired length of the tracing member 42 has been inserted, the service personnel couple a device capable of producing an electrical current or signal on the tracing member 42, often referred to as the “transmitter”. A monitoring device 78 may then detect the electric current. In the exemplary embodiment, the monitoring device 78 is a RD4000 manufactured by Radiodetection Ltd. Once the monitoring device 78 locates the signal from the current injected on the tracing member 42, the location of the conduit 72 may be marked on the ground.

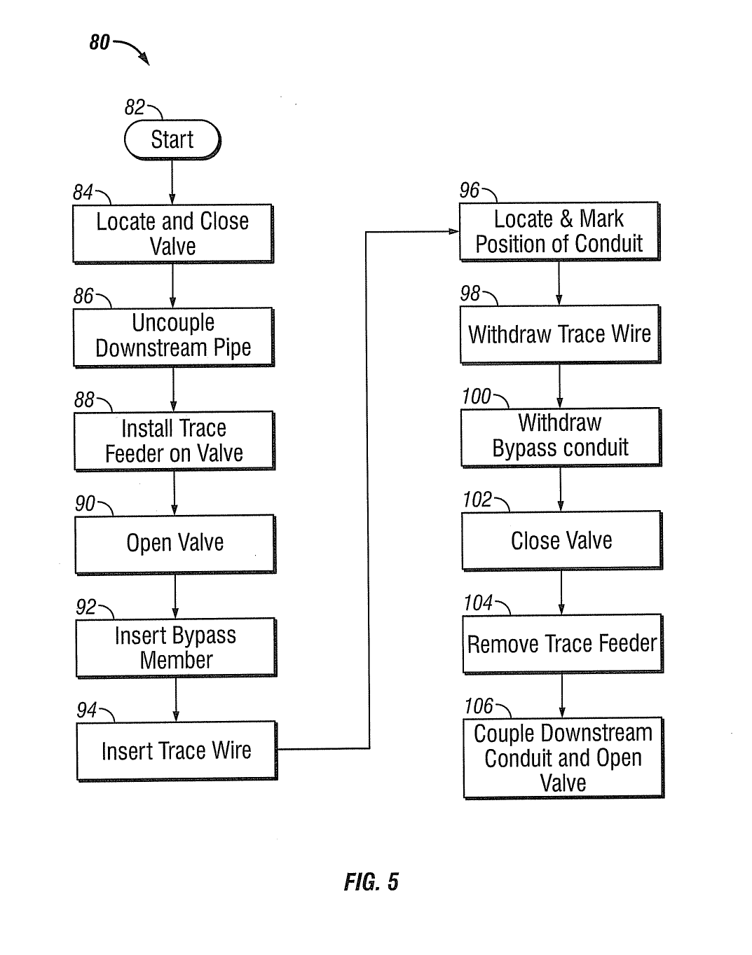

Referring now to FIG. 5, a method 80 of determining the location of an underground nonconductive conduit, such as a natural gas conduit. The method 80 starts in block 82 and proceeds to block 84 where a desired valve on one end of the conduit is located and closed. In the exemplary embodiment the valve may be located above ground, such as a valve 62 arranged adjacent the residence 75 for example, or below ground in a service box for example. With the valve closed, the method 80 proceeds to block 86 where the conduit downstream from the valve is uncoupled.

Once the conduit is detached, the tracing device 20 is coupled to the valve with the bypass member 34 in the first or retracted position in block 88. The valve is opened in block 90 and the bypass member 34 is moved in block 92 to the second position wherein the bypass member 34 passes through the valve. As discussed herein, with the bypass member 34 in the extended position, the tracing member 42 may be inserted in block 94 and it will pass through the valve without becoming entangled with the inner features of the valve. The trace member 42 is extended into the conduit a length substantially the length of the conduit that the service personnel desire to locate.

Next, the method 80 proceeds to block 96 where the service personnel use a monitoring device to locate and mark (e.g. with paint or flags) the position of the conduit. As discussed above, the process of locating the position of the conduit includes the injecting of a signal or electrical current on the tracing member 42. Once the conduit is located, the tracing member 42 is with drawn in block 98 and the bypass member 34 in moved to the first position in block 100. With the bypass member 34 moved, the valve is free to be closed and is closed in block 102. The tracing device 20 is removed in block 104 and downstream conduit is reconnected and the valve opened once again in block 106.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A device for locating a nonconductive conduit having a valve comprising:
a first fitting having an end adapted to couple with said valve;
a bypass member having an axial opening, said bypass member being sealingly coupled to said first fitting and having a first end within said first fitting, said bypass member being movable between a first position and a second position;
an end member operably coupled to a second end of said bypass member; and,
a tracing member sealingly coupled to said end member and having a portion arranged partially within said axial opening, said tracing member being movable through said end member and said bypass member.

2. The device of claim 1 further comprising a first seal operably coupled between said end member and said bypass member.

3. The device of claim 2 wherein said first seal is made from a polychloroprene material.

4. The device of claim 2 further comprising a second fitting arranged between said end member and said first fitting, said bypass member being coupled to said second fitting.

5. The device of claim 4 further comprising a second seal disposed within said first fitting, said second seal engaging said bypass member to provide a sliding seal about said bypass member.

6. The device of claim 5 wherein said bypass member has a generally rectangular cross-section that is sized to extend through said valve.

7. A method of locating a conduit comprising:
closing a valve coupled to said conduit adjacent a portion of said conduit to be located;
coupling a tracing device to one side of said valve, said tracing device having a bypass member and a tracing member;
opening said valve;
moving said bypass member from a first position to a second position; and,
inserting said tracing member into said conduit.

8. The method of claim 7 further comprising:
applying an electrical signal to said tracing member; and,
locating an electrical field created by said electrical signal.

9. The method of claim 8 further comprising providing a first seal between said bypass member and a coupling portion of said tracing device.

10. The method of claim 9 further comprising providing a second seal between said tracing member and a fitting coupled to said coupling portion of said tracing device.

11. The method of claim 10 further comprising:
removing said tracing member from said conduit;
moving said bypass member from said second position to said first position;
closing said valve; and,
removing said tracing device from said valve.

12. A tracing device for locating a conduit comprising:
a coupling portion;
a bypass member sealingly coupled to said coupling portion;
a fitting coupled to said bypass member; and,
a tracer member sealingly coupled to said fitting.

13. The tracing device of claim 12 wherein said bypass member is movable between a first position and a second position, and said tracer member is movably coupled to said fitting.

14. The tracing device of claim 13 wherein said bypass member includes an axial opening and said tracer member is at least partially arranged within said axial opening.

15. The tracing device of claim 14 wherein said coupling portion includes a hollow interior portion.

16. The tracing device of claim 15 wherein said bypass member has a first end coupled to said fitting and a second end, wherein said second end is positioned within or adjacent to said hollow interior portion when said bypass member is in said first position.
